(19) United States
(12) Patent Application Publication
(10) Pub. No.: US 2025/0189780 A1
(43) Pub. Date: Jun. 12, 2025

(54) PHOSPHOR WHEEL, LIGHT SOURCE DEVICE, PROJECTION TYPE IMAGE DISPLAY DEVICE, AND METHOD FOR PRODUCING PHOSPHOR WHEEL

(71) Applicant: Panasonic Holdings Corporation, Osaka (JP)

(72) Inventors: Takashi IKEDA, Osaka (JP); Yusaku NISHIKAWA, Osaka (JP); Yasunori MIURA, Osaka (JP); Yasuto SHIROI, Osaka (JP); Taiki BESSHO, Osaka (JP)

(21) Appl. No.: 19/060,183

(22) Filed: Feb. 21, 2025

Related U.S. Application Data
(63) Continuation of application No. PCT/JP2023/028006, filed on Jul. 31, 2023.

(30) Foreign Application Priority Data
Aug. 23, 2022 (JP) 2022-132417

(51) Int. Cl. G02B 26/00; G03B 21/20

(52) U.S. Cl. CPC G02B 26/008; G03B 21/204; G03B 21/2066

(57) ABSTRACT

A phosphor wheel comprises a rotatable substrate, a plurality of wavelength conversion layers, and an adhesive layer disposed between the substrate and the plurality of wavelength conversion layers. At least a first wavelength conversion layer among the plurality of wavelength conversion layers is a sintered body type wavelength conversion layer made of a sintered body of first wavelength conversion particles that wavelength-convert excitation light into light of a first wavelength. At least a second wavelength conversion layer among the plurality of wavelength conversion layers is a mixed layer type wavelength conversion layer that is a mixed layer of a support and second wavelength conversion particles filled in the support that wavelength-convert the excitation light into light of a second wavelength different from the first wavelength.

### CROSS REFERENCE TO RELATED APPLICATION

This application claims priorities of Japanese Patent Application No. 2022-132417 filed on Aug. 23, 2022 and PCT Application No. PCT/JP2023/028006 filed on Jul. 31, 2023, the contents of which are incorporated herein by reference.

### BACKGROUND

### 1. Technical Field

The present disclosure relates to a phosphor wheel that is used in a light source device of a projection type image display device, a light source device, a projection type image display device, and a method for producing a phosphor wheel.

### 2. Description of the Related Art

A conventional phosphor wheel using a fluorescent layer (wavelength conversion layer) has hitherto employed a mode having only a so-called mixed layer type wavelength conversion layer and applying a resin paste containing phosphor particles dispersed and a mode having only a sintered body type wavelength conversion layer made of a sintered body of phosphor particles (see, e.g., WO2018042949).

The former phosphor wheel using the mixed layer type wavelength conversion layer has a wide range of fluorescent wavelengths to choose from and is cost-effective, but has issues with conversion efficiency and heat resistance. On the other hand, the phosphor wheel using the sintered body type wavelength conversion layer has excellent conversion efficiency and heat resistance, but has a cost issue.

### SUMMARY

The present disclosure is intended to solve the above-mentioned conventional problems, and one non-limiting and exemplary embodiments provides a phosphor wheel securing an excellent balance between conversion efficiency, heat resistance, and cost.

In one general aspect, the techniques disclosed here feature: a phosphor wheel includes a rotatable substrate, a plurality of wavelength conversion layers, and an adhesive layer disposed between the substrate and the plurality of wavelength conversion layers. At least a first wavelength conversion layer among the plurality of wavelength conversion layers is a sintered body type wavelength conversion layer made of a sintered body of first wavelength conversion particles that wavelength-convert excitation light into light of a first wavelength. At least a second wavelength conversion layer among the plurality of wavelength conversion layers is a mixed layer type wavelength conversion layer that is a mixed layer of a support and second wavelength conversion particles filled in the support that wavelength-convert the excitation light into light of a second wavelength different from the first wavelength.

In another general aspect, the techniques disclosed here feature: a method for producing a phosphor wheel includes:
applying an adhesive layer onto a substrate;
sticking onto the substrate a sintered body of first wavelength conversion particles that wavelength-convert excitation light into light of a first wavelength;
hardening the adhesive layer to form a sintered body type wavelength conversion layer;
applying a mixed layer onto a substrate on a circumference identical to that of the sintered body type wavelength conversion layer, the mixed layer being made of a mixture of a support and second wavelength conversion particles that wavelength-convert the excitation light into light of a second wavelength different from the first wavelength; and
hardening the mixed layer to form a mixed layer type wavelength conversion layer.

The phosphor wheel according to the present disclosure includes the sintered body type wavelength conversion layer and the mixed layer type wavelength conversion layer. This ensures balance between conversion efficiency, heat resistance, and cost.

Additional benefits and advantages of the disclosed embodiments will be apparent from the specification and figures. The benefits and/or advantages may be individually provided by the various embodiments and features of the specification and drawings disclosure, and need not all be provided in order to obtain one or more of the same.

### BRIEF DESCRIPTION OF DRAWINGS

The present disclosure will become readily understood from the following description of non-limiting and exemplary embodiments thereof made with reference to the accompanying drawings, in which like parts are designated by like reference numeral and in which:

FIG. 1 is a schematic plan view showing a planar configuration of a phosphor wheel according a first embodiment;

FIG. 2 is a flowchart showing a method for producing the phosphor wheel according to the first embodiment;

FIGS. 3A to 3C are flowchart showing a method for producing the phosphor wheel of FIG. 2, with FIG. 3A being a plan view depicting details of a step of aligning, on a substrate, a sintered body type wavelength conversion layer made of a sintered body of wavelength conversion particles, FIG. 3B being a front view of FIG. 3A, FIG. 3C being a plan view depicting the sintered body type wavelength conversion layer, seen through the substrate;

FIG. 4 is a plan view, at the step of FIGS. 3A to 3C aligning and sticking the sintered body type wavelength conversion layer onto the substrate of FIGS. 3A to 3C, showing positional relationship between guide pins adjacently arranged on the sintered body type wavelength conversion layer and sticking positions on the substrate;

FIG. 5 is a front view, at the step of aligning and sticking the sintered body type wavelength conversion layer onto the substrate of FIGS. 3A to 3C, showing the direction in which the sintered body type wavelength conversion layer is stuck on the substrate;

FIG. 6 is a diagram showing a configuration of a light source device that uses the phosphor wheel according to the first embodiment;

FIG. 7 is a diagram showing a configuration of a projection type image display device mounted with the light source device that uses the phosphor wheel according to the first embodiment;

FIG. 8 is a schematic plan view showing a planar configuration of a phosphor wheel according to a second embodiment;

FIG. 9 is a diagram showing a configuration of a light source device that uses the phosphor wheel according to the second embodiment;

FIG. 10 is a diagram showing a configuration of a projection type image display device mounted with the light source device that uses the phosphor wheel according to the second embodiment;

FIG. 11 is a schematic plan view showing a planar configuration of a phosphor wheel according to a third embodiment;

FIGS. 12A and 12B are diagrams illustrating alignment of the sintered body type wavelength conversion layer (whose center angle is smaller than the design value) at the time of producing the phosphor wheel according to the third embodiment; and

FIGS. 13A and 13B are diagrams illustrating alignment of the sintered body type wavelength conversion layer (whose center angle is larger than the design value) at the time of producing the phosphor wheel according to the third embodiment.

### DETAILED DESCRIPTION

A phosphor wheel according to a first aspect comprises a rotatable substrate, a plurality of wavelength conversion layers, and an adhesive layer disposed between the substrate and the plurality of wavelength conversion layers. At least a first wavelength conversion layer among the plurality of wavelength conversion layers is a sintered body type wavelength conversion layer made of a sintered body of first wavelength conversion particles that wavelength-convert excitation light into light of a first wavelength. At least a second wavelength conversion layer among the plurality of wavelength conversion layers is a mixed layer type wavelength conversion layer that is a mixed layer of a support and second wavelength conversion particles filled in the support that wavelength-convert the excitation light into light of a second wavelength different from the first wavelength. In the phosphor wheel according to a second aspect in addition to the first aspect, the first wavelength conversion layer and the second wavelength conversion layer may be arranged adjacent to each other on the substrate.

In the phosphor wheel according to a third aspect in addition to the first or second aspect, the first wavelength conversion layer and the second wavelength conversion layer may have their respective inner radii and their respective outer radii, at least one of the inner radii or the outer radii being different between the first wavelength conversion layer and the second wavelength conversion layer.

In the phosphor wheel according to a fourth aspect in addition to any one of the first to third aspects, the first wavelength conversion layer and the second wavelength conversion layer have different widths in a radial direction from a rotation center of the substrate.

In the phosphor wheel according to a fifth aspect in addition to any one of the first to fourth aspects, the inner radius of the first wavelength conversion layer from a rotation center of the substrate may be larger than the inner radius of the second wavelength conversion layer from the rotation center of the substrate, and the outer radius of the first wavelength conversion layer from the rotation center of the substrate may be smaller than the outer radius of the second wavelength conversion layer from the rotation center of the substrate.

The phosphor wheel according to a sixth aspect in addition to any one of the first to fifth aspects, the substrate may define an opening disposed on an identical circumference around a rotation center of the substrate on which the plurality of wavelength conversion layers are arranged.

The phosphor wheel according to a seventh aspect in addition to any one of the first to fifth aspects, may comprise a reflective region disposed on an identical circumference around a rotation center of the substrate on which the plurality of wavelength conversion layers are arranged.

A light source device according to an eighth aspect comprises the phosphor wheel according to any one of the first to seventh aspects.

A projection type image display device according to ninth aspect comprises the light source device according to the eighth aspect.

A method for producing a phosphor wheel according to a tenth aspect comprises the steps of: applying an adhesive layer onto a substrate; sticking onto the substrate a sintered body of first wavelength conversion particles that wavelength-convert excitation light into light of a first wavelength; hardening the adhesive layer to form a sintered body type wavelength conversion layer; applying a mixed layer onto a substrate on a circumference identical to that of the sintered body type wavelength conversion layer, the mixed layer being made of a mixture of a support and second wavelength conversion particles that wavelength-convert the excitation light into light of a second wavelength different from the first wavelength; and hardening the mixed layer to form a mixed layer type wavelength conversion layer.

In the method for producing a phosphor wheel according to an eleventh aspect in addition to the tenth aspect, the step of forming the sintered body type wavelength conversion layer may include disposing a guide pin for alignment around a sintered body of the first wavelength conversion particles, relatively moving, along the guide pin, the substrate and the sintered body of the first wavelength conversion particles in a direction normal to a surface; and sticking the sintered body of the first wavelength conversion particles onto a site of the substrate where the adhesive layer is applied.

In the method for producing a phosphor wheel according to a twelfth aspect in addition to the eleventh aspect, the step of forming the mixed layer type wavelength conversion layer may include applying the mixed layer in which the second wavelength conversion particles and the support are mixed, onto the substrate at a site adjacent to the sintered body of the first wavelength conversion particles, other than a site corresponding to the guide pin.

Embodiments will now be described in detail with appropriate reference to the drawings. Note, however, that more detailed explanations than necessary may be omitted. For example, detailed explanations of already well-known matters and duplicate explanations for substantially the same configurations may be omitted. This is to avoid unnecessary redundancy in the following description and to facilitate understanding by those skilled in the art. In the drawings, substantially the same members are given the same reference numerals.

The accompanying drawings and the following description are provided in order that those skilled in the art fully understand the present disclosure, but are not intended to thereby limit the subject matter defined in the appended claims.

### First Embodiment

### [1-1 Configuration of Phosphor Wheel]

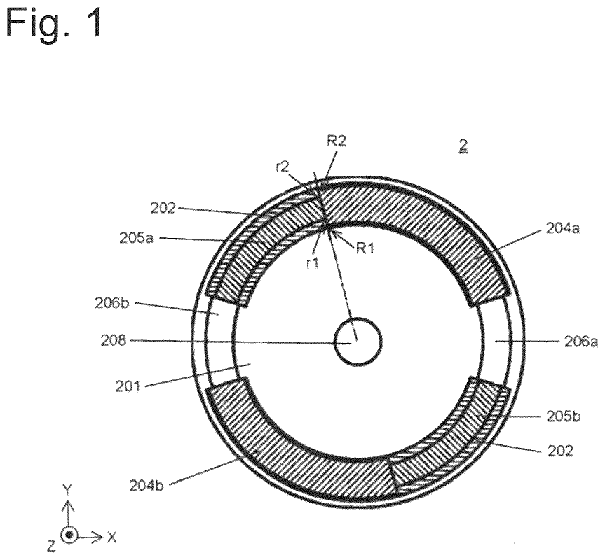

A configuration of a phosphor wheel 2 according to a first embodiment will hereinafter be described in detail. FIG. 1 is a schematic plan view showing a planar configuration of the phosphor wheel 2 according to the first embodiment. As shown in FIG. 1, the phosphor wheel 2 according to the first embodiment includes a rotatable substrate 201, a plurality of wavelength conversion layers 204a, 204b, 205a, and 205b, and an adhesive layer 202 (reflective layer) disposed between the substrate 201 and the plurality of wavelength conversion layers 204a, 204b, 205a, and 205b. The plurality of wavelength conversion layers 204a, 204b, 205a, and 205b are arranged on the substrate 201 and wavelength-convert the same excitation light into light having a plurality of wavelengths. The plurality of wavelength conversion layers 204a, 204b, 205a, and 205b include sintered body type wavelength conversion layers 204a and 204b and mixed layer type wavelength conversion layers 206a and 205b. The sintered body type wavelength conversion layers 204a and 204b are made of a sintered body of first wavelength conversion particles that wavelength-convert excitation light into light of a first wavelength. The mixed layer type wavelength conversion layers 205a and 205b are mixed layers of a support and second wavelength conversion particles filled in the support that wavelength-convert excitation light into light of a second wavelength.

According to this phosphor wheel 2, because of having the sintered body type wavelength conversion layers 204a and 204b and the mixed layer type wavelength conversion layers 205a and 205b, an excellent balance is achieved between the conversion efficiency, heat resistance, and cost.

Members making up this phosphor wheel 2 will be described below.

### <Substrate>

The substrate 201 may be, for example, an aluminum substrate having excellent heat dissipation properties. The material of the substrate 201 is not limited to aluminum, but may be other metals. It may also be a light-transmissible substrate of glass, sapphire, or the like, or a light-transmissible substrate of glass, sapphire, or the like, having a reflective region. The substrate 201 has a motor mounting hole 208 for mounting a motor for rotation. The motor may be mounted in a method other than using the motor mounting hole 208.

### <Wavelength Conversion Layer>

The wavelength conversion layers include the sintered body type wavelength conversion layers 204a and 204b and the mixed layer type wavelength conversion layers 205a and 205b. These wavelength conversion layers 204a, 204b, 205a, and 205b are arranged on the substrate 201 along the same circumference around the rotation center of the substrate 201. The substrate 201 may define openings 206a and 206b disposed on the same circumference. Alternatively, as shown in a second embodiment described later, reflective regions may be disposed instead of the openings. The sintered body type wavelength conversion layers 204a and 204b and the mixed layer type wavelength conversion layers 205a and 205b may be adjacent to each other on the same circumference or may be adjacent with the openings 206a and 206b in between. The sintered body type wavelength conversion layers 204a and 204b and the mixed layer type wavelength conversion layers 205a and 205b may be adjacent with a small gap in between because the temperature increases when they overlap.

The sintered body type wavelength conversion layers 204a and 204b and the mixed layer type wavelength conversion layers 205a and 205b may have inner radii R1 and r1 and outer radii R2 and r2, respectively, from the rotation center of the substrate, at least one of which is different between the sintered body type wavelength conversion layer and the mixed layer type wavelength conversion layer. For example, in the example shown in FIG. 1, the inner radius R1 of the sintered body type wavelength conversion layers 204a and 204b is less than the inner radius r1 of the mixed layer type wavelength conversion layers 205a and 205b (R1<r1), while the outer radius R2 of the sintered body type wavelength conversion layers 204a and 204b is greater than the outer radius r2 of the mixed layer type wavelength conversion layers 205a and 205b (R2>r2).

Also, the mixed layer type wavelength conversion layers 205a and 205b and the sintered body type wavelength conversion layers 204a and 204b may be different in the radial width from the rotation center of the substrate 201. For example, in the example shown in FIG. 1, the radial width (r2−r1) of the mixed layer type wavelength conversion layers 205a and 205b is smaller than the radial width (R2−R1) of the sintered body type wavelength conversion layers 204a and 204b, that is, (r2−r1)<(R2−R1) is established.

By satisfying one of the above conditions, at least one of the pairs of the radial positions (r1, r2, R1, and R2) can be different between the mixed layer type wavelength conversion layers 205a and 205b and the sintered body type wavelength conversion layers 204a and 204b. As a result, at the time of producing the phosphor wheel 2, guide pins arranged around the sintered body of the first wavelength conversion particles can be positioned radially away from the location where the mixed layer type wavelength conversion layer is to be disposed, which makes it easier to align the sintered body type wavelength conversion layers 204a and 204b on the substrate when adhering them to the substrate.

### <Sintered Body Type Wavelength Conversion Layer>

The sintered body type wavelength conversion layers 204a and 204b are made of a sintered body of first wavelength conversion particles that wavelength-convert excitation light into light of a first wavelength

### <First Wavelength Conversion Particle>

The first wavelength conversion particle is a so-called phosphor particle, and may be, for example, a particle having a garnet structure. The chemical formula of the garnet structure may be, for example, Y₃Al₅O₁₂ that wavelength-converts blue excitation light into yellow fluorescence, or Lu₃Al₅O₁₂ that wavelength-converts blue excitation light into green fluorescence. It may also be (Y, Lu)₃Al₅O₁₂ that is a mixture thereof. The activator may be, for example, Ce or Gd. It may be a particle that converts blue excitation light into fluorescence other than the above-mentioned yellow and green.

### <Mixed Layer Type Wavelength Conversion Layer>

The mixed layer type wavelength conversion layers 205a and 205b are mixed layers of the support and the second wavelength conversion particles filled in the support that wavelength-convert excitation light into light of the second wavelength.

### <Second Wavelength Conversion Particle>

The second wavelength conversion particle is a so-called phosphor particle, and may be, for example, a particle having a garnet structure, similar to the first wavelength conversion particle. The chemical formula of the garnet structure may be, for example, Y₃Al₅O₁₂ that wavelength-converts blue excitation light into yellow fluorescence, or Lu₃Al₅O₁₂ that wavelength-converts blue excitation light into green fluorescence. It may also be (Y, Lu)₃Al₅O₁₂ that is a mixture thereof. The activator may be, for example, Ce or Gd. It may be a particle that converts blue excitation light into fluorescence other than the above-mentioned yellow and green. By changing the structure, composition, etc., it is possible to vary the first wavelength and the second wavelength to be wavelength-converted in the first wavelength conversion particle and the second wavelength conversion particle.

### <Support>

The support is a medium in which the second wavelength conversion particles are dispersed, and may be, for example, a heat-resistant transparent resin such as silicone or silsesquioxane, or glass silicon dioxide, silicate glass, or other glass.

### <Adhesive Layer>

The adhesive layer 202 is disposed between the substrate 201 and the sintered body type wavelength conversion layers 204a and 204b and between the substrate 201 and the mixed layer type wavelength conversion layers 205a and 205b. The adhesive layer 202 is disposed to adhere the sintered body type wavelength conversion layers 204a and 204b to the substrate 201 and acts as a reflective layer that reflects first light generated by wavelength conversion by the sintered body type wavelength conversion layers 204a and 204b and second light generated by wavelength conversion by the mixed layer type wavelength conversion layers 205a and 205b. The reflective layer also reflects excitation light that was not absorbed by the sintered body type wavelength conversion layers 204a and 204b and the mixed layer type wavelength conversion layers 205a and 205b. The excitation light reflected by the reflective layer is absorbed again in the sintered body type wavelength conversion layers 204a and 204b or the mixed layer type wavelength conversion layers 205a and 205b and is converted into the first light or the second light. This improves the efficiency of wavelength conversion in the sintered body type wavelength conversion layers 204a and 204b and the mixed layer type wavelength conversion layers 205a and 205b. The inner and outer radii of the adhesive layer 202 are substantially the same as the inner radius R1 and the outer radius R2, respectively, of the sintered body type wavelength conversion layers 204a and 204b. That is, the width of the adhesive layer 202 is substantially the same as the width of the sintered body type wavelength conversion layers 204a and 204b and is greater than the width of the mixed layer type wavelength conversion layers 205a and 205b.

### <Opening>

The substrate 201 may define one or more openings 206. When the openings 206 are defined, the excitation light passes through the opening 206 and therefore blue light is used as the excitation light.

### <Method for Producing Phosphor Wheel>

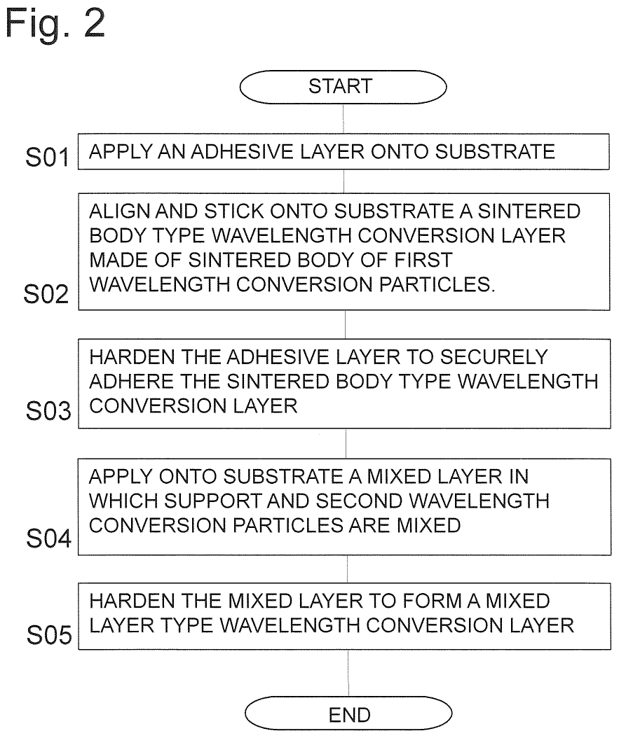

FIG. 2 is a flowchart showing a method for producing a phosphor wheel according to the first embodiment. The method for producing a phosphor wheel according to the first embodiment includes the following steps.
(1) Apply an adhesive layer onto a substrate (S01). The adhesive layer may be a mixed layer in which a heat-resistant resin such as, e.g., silicone or silsesquioxane is filled with particles having a high reflectivity. In this case, it also functions as a reflective layer. The adhesive layer may also be a mixed layer in which a heat-resistant resin such as silicone or silsesquioxane is filled with particles having a high thermal conductivity. In this case, it also functions as a thermal conductive layer. This provides the effect of suppressing the temperature rise of the phosphor layer. Furthermore, both the high reflective particles and the high thermal conductive particles may be mixed, or a heat-resistant resin such as silicone or silsesquioxane without mixing particles may be used.
(2) Stick onto the substrate a sintered body of first wavelength conversion particles that wavelength-convert the excitation light into light of a first wavelength (S02). The sticking of the sintered body of the first wavelength conversion particles will be described later.
(3) Harden the adhesive layer to securely adhere the sintered body type wavelength conversion layer (S03).
(4) Apply, on the same circumference as the sintered body type wavelength conversion layer, onto the substrate a mixed layer in which a support and second wavelength conversion particles that wavelength-convert excitation light into light of a second wavelength are mixed (S04).
(5) Harden the mixed layer to form a mixed layer type wavelength conversion layer (S05).

Through the above steps, the phosphor wheel according to the first embodiment is obtained.

### <Step of Sticking Sintered Body of First Wavelength Conversion Particles>

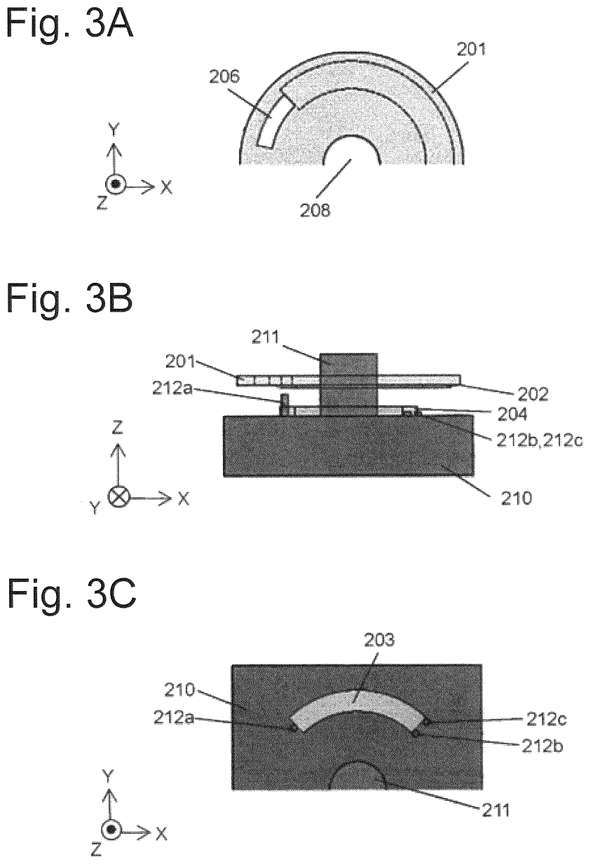

FIGS. 3A to 3C are a flowchart showing a method for producing the phosphor wheel of FIG. 2. FIG. 3A is a plan view depicting details of a step of aligning and sticking onto a substrate, a sintered body type wavelength conversion layer 204 made of a sintered body of first wavelength conversion particles. FIG. 3B is a front view of FIG. 3A, and FIG. 3C is a plan view depicting the sintered body type wavelength conversion layer 204, seen through the substrate.

As shown in FIGS. 3A to 3C, at the step of sticking the sintered body type wavelength conversion layer 204 onto the substrate 201, guide pins 211, 212a, 212b, and 212c are used for alignment of the sintered body type wavelength conversion layers 204 onto the substrate 201. The guide pins 211, 212a, 212b, and 212c are arranged on a sticking base 210. The guide pin 211 is disposed passing through the motor mounting hole 208. The guide pin 212a is disposed at the tip of the left end of the sintered body type wavelength conversion layer 204 in such a manner as to pass through the opening 206. The guide pins 212b and 212c are disposed on both sides of the tip of the right end of the sintered body type wavelength conversion layer 204. As shown in FIG. 3B, the height of the guide pins 212b and 212c is lower than the height of the sintered body type wavelength conversion layer 204, for example, by about several tens of um. Note that, by other means not using the sticking base 210, the guide pins 211, 212a, 212b, and 212c may be disposed.

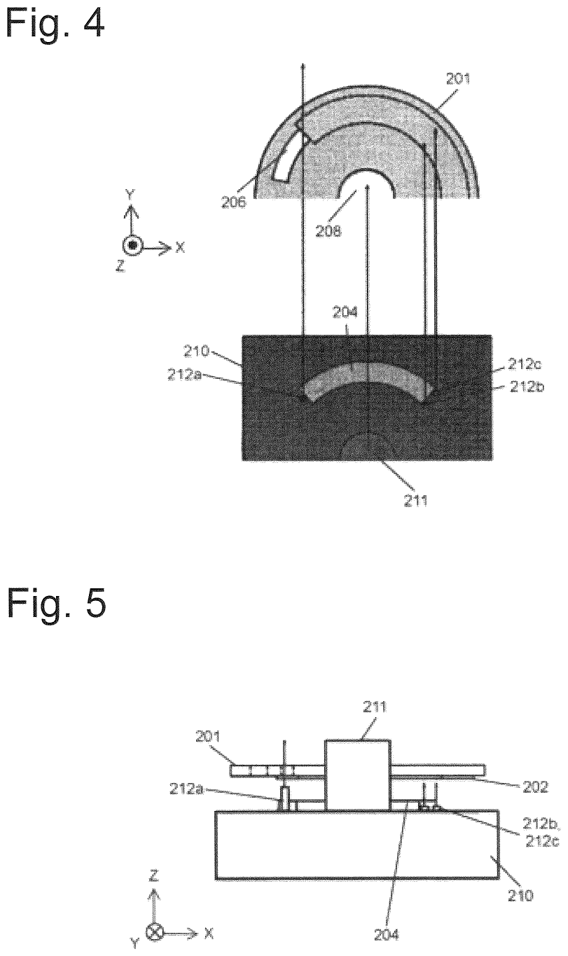

FIG. 4 is a plan view, at the step of FIGS. 3A to 3C aligning the sintered body type wavelength conversion layer 204 onto the substrate 201, showing positional relationship between the guide pins 212a, 212b, and 212c adjacently arranged on the sintered body type wavelength conversion layer 204 and sticking positions on the substrate 201. FIG. 5 is a front view, at the step of aligning and sticking the sintered body type wavelength conversion layer 204 onto the substrate 201 of FIGS. 3A to 3C, showing the direction in which the sintered body type wavelength conversion layer 204 is stuck on the substrate 201.

The step of sticking the sintered body type wavelength conversion layer 204 onto the substrate 201 is carried out by relatively moving the substrate 201 and the sintered body type wavelength conversion layer 204 in the Z-direction to stick the sintered body type wavelength conversion layer 204 onto the adhesive layer 202 of the substrate 201.

The guide pin 212a at the left end of the sintered body type wavelength conversion layer 204 is arranged passing through the opening 206 of the substrate 201, while the guide pins 212b and 212c at the right end are arranged sandwiching the site where the mixed layer type wavelength conversion layer 205 is disposed. The height of the guide pins 212b and 212c at the right end C is lower than the height of the sintered body type wavelength conversion layer 204, for example, by about several tens of um. Consequently, as shown in FIG. 5, the guide pins 212b and 212c can be prevented from coming into contact with the substrate 201 when relatively moving the substrate 201 and the sintered body type wavelength conversion layer 204 in the X-direction to adhere the sintered body type wavelength conversion layer 204 onto the adhesive layer 202 of the substrate 201. This can suppress any subsequent influence on the site where the mixed layer type wavelength conversion layer is disposed. According to this method for producing a phosphor wheel, the sintered body type wavelength conversion layer and the mixed layer type wavelength conversion layer can be formed. This makes it possible to achieve a balance between conversion efficiency, heat resistance, and cost.

### [1-2 Light Source Device]

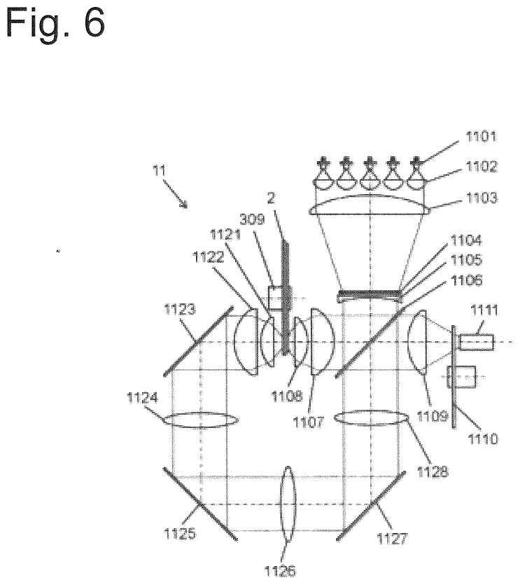

Details of a light source device 11 using the phosphor wheel 2 according to the first embodiment will be described below. FIG. 6 is a diagram showing a configuration of the light source device 11 that uses the phosphor wheel 2 according to the first embodiment. Hereinafter, description will be given using the phosphor wheel 2 according to the first embodiment shown in FIG. 1.

Laser light having a blue wavelength range emitted from a plurality of laser light sources 1101 is collimated by a plurality of collimator lenses 1102 each arranged corresponding to each of the laser light sources 1101. The collimated blue light enters a succeeding convex lens 1103 to reduce its luminous flux width and then enters a diffuser plate 1104 which follows for diffusion to improve the uniformity of light. The blue light having improved light uniformity is incident on a succeeding concave lens 1105 and collimated into a parallel luminous flux.

The blue light collimated into a parallel luminous flux impinges on a color separation/combining mirror 1106 disposed at an inclination angle of approx. 45 degrees to the optical axis and changes 90 degrees the direction of travel of the light, to enter a succeeding convex lens 1107. The color separation/combining mirror 1106 has spectral characteristics that reflect light having a blue light wavelength range emitted from the laser light sources 1101 and that transmit light having a fluorescence wavelength range obtained by wavelength-converting in the phosphor wheel 2 described later the blue light that is excitation light emitted from the laser light sources 1101.

Although in this example, the color separation/combining mirror 1106 has the spectral characteristics focusing on the wavelength characteristics of the blue light from the laser light sources and the wavelength-converted fluorescence, the present invention is not limited thereto, and may have spectral characteristics focusing on, for example, polarization and wavelength. Specifically, the polarization direction of the laser light sources may be focused on so that the polarization direction of the blue light from the laser light sources is adjusted to the same direction. This may allow the color separation/combining mirror to have spectral characteristics focusing on polarization and wavelength, such as reflecting light of the blue wavelength range and polarization direction from the laser light sources and transmitting light of the wavelength range of the wavelength-converted fluorescence.

The blue light incident on the convex lens 1107 enters, in cooperation with a succeeding convex lens 1108, the wavelength conversion layers 204a, 204b, 205a, and 205b and the openings 206a and 206b on the same radius arranged on the succeeding phosphor wheel 2.

The phosphor wheel 2 includes a motor 309. Arrangement is such that around a rotation axis of the motor 309, the blue excitation light condensed by the convex lenses 1107 and 1108 enters a region of the same radius from the rotation center in which the wavelength conversion layers 204a, 204b, 205a, and 205b and the opening 206 are arranged.

First, the blue light condensed on the wavelength conversion layers 204a, 204b, 205a, and 205b of the phosphor wheel 2 by the convex lenses 1107 and 1108 is wavelength-converted into fluorescence and changes the direction of travel of the light by 180 degrees to reenter the convex lenses 1108 and 1107 in the mentioned order to be collimated into a parallel luminous flux. The fluorescence wavelength-converted by the phosphor wheel 2 has wavelength regions optimized to form, for example, white light in cooperation with the blue light emitted from the laser light sources 1101.

The fluorescence is output from the convex lens 1107 and collimated into a parallel luminous flux reenters the color separation/combining mirror 1106. Since as described earlier, the color separation/combining mirror 1106 has the characteristic of transmitting light of a fluorescence wavelength range and is arranged at the angle of approx. 45 degrees to the optical axis, it transmits fluorescence intactly without changing the direction of travel of the fluorescence.

Next, the blue light from the laser light sources 1101 condensed onto the openings 206a and 206b of the phosphor wheel 2 passes through the phosphor wheel 2 and is collimated into a parallel luminous flux by succeeding convex lenses 1121 and 1122. Then, through a posteriorly positioned relay lens system including three mirrors 1123, 1125, and 1127 and three convex lenses 1124, 1126, and 1128, light is guided to the color separation/combining mirror 1106 so that the light collimated into a parallel luminous flux enters from 180 degrees opposite direction to the direction in which light from the laser light sources 1101 enters.

Although the relay optical system is configured here using three mirrors and three convex lenses, other configurations may be used as long as they have similar performance.

Since the color separation/combining mirror 1106 has the characteristic of reflecting blue light from the laser light sources 1101, the blue light incident on the color separation/combining mirror 1106 from the convex lens 1128 is reflected with its direction of travel changed by 90 degrees.

Thus, the above configuration allows fluorescence and blue light combined together in a time-division manner by the color separation/combining mirror 1106 to enter a convex lens 1109 that is a succeeding optical system.

The time-divided fluorescence and blue light incident on the convex lens 1109 from the color separation/combining mirror 1106 are condensed by the convex lens 1109 in the vicinity of the entrance end of a rod integrator 1111 that will be described later. The light leaving the convex lens 1109 enters a color filter wheel 1110 before entering the rod integrator 1111. The color filter wheel 1110 is synchronized with the phosphor wheel 2 using a synchronizing circuit (not shown), and is composed of a plurality of filters having a spectral characteristic that transmits some or all of the wavelength ranges of blue light and fluorescent light depending on the characteristics of the optical system.

The color filter wheel 1110 has: a region that transmits yellow fluorescence from the phosphor wheel 2 with its unchanged fluorescence wavelength range; a region that transmits green fluorescence from the phosphor wheel 2 with its unchanged fluorescence wavelength range; a region that reflects light in the green wavelength range of the fluorescence and transmits light in the red wavelength range, and a region that transmits intactly light in the blue wavelength range passing through the openings 206a and 206b from the phosphor wheel 2. Since the phosphor wheel 2 and the color filter wheel 1110 rotate in synchronism, light of different wavelength range is condensed in a time series near the entrance end of the rod integrator 1111. Note that the configuration of the color filter wheel is not limited to the above configuration, and may be changed as appropriate depending on the specifications of the phosphor wheel, light source device, and projection-type image display device.

The light having a wavelength range different in a time division manner incident on the rod integrator 1111 is homogenized by the rod integrator and output from the exit end. Although in the explanation of FIG. 6, the color filter wheel 1110 is disposed near the entrance side of the rod integrator 1111, it may be disposed near the exit side thereof.

### <Effect>

In the light source device 11 that uses the phosphor wheel 2 according to the first embodiment, balance can be achieved between conversion efficiency, heat resistance, and cost.

### [1-3 Projection Type Image Display Device]

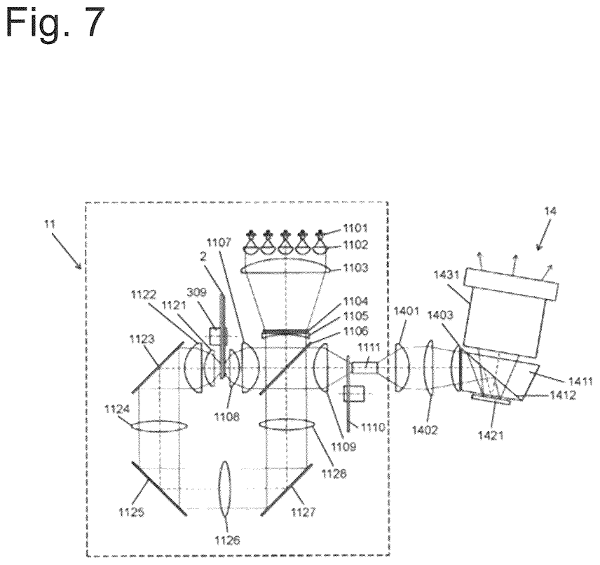

Hereinafter, description will be given of details of a projection type image display device 14 employing the light source device 11 that uses the phosphor wheel 2 according to the first embodiment. FIG. 7 is a diagram showing a configuration of the projection type image display device 14 employing the light source device 11 that uses the phosphor wheel 2 according to the first embodiment. Since the configuration of the light source device 11 using the phosphor wheel 2 according to the first embodiment has been described above, the description thereof will be omitted here, and the behavior of light after emission from the rod integrator 1111 will be described in detail.

The light leaving the rod integrator 1111 is mapped onto a DMD 1421 that will be described later, through a relay lens system including convex lenses 1401, 1402, and 1403.

The light passing through the convex lenses 1401, 1402, and 1403 and incident on a total reflection prism 1411 enters a minute gap 1412 of the total reflection prism 1411 at an angle equal to or greater than the total reflection angle and is reflected to change the direction of travel of light to enter the DMD 1421.

In synchronization with colored light output from the combination of the phosphor wheel 2 and the color filter wheel 1110, the DMD 1421 changes the direction of a micromirror to change the direction of travel of the light, for light emission, in response to a signal from an image circuit not shown. The light whose direction of travel has been changed by the DMD 1421 in response to an image signal enters the minute gap 1412 of the total reflection prism 1411 at an angle equal to or less than the total reflection angle to pass through as it is, and enters a projection lens 1431 to be projected onto a screen not shown.

### <Effect>

In the projection type image display device 14 using the light source device 11 that uses the phosphor wheel 2 according to the first embodiment, balance can be achieved between conversion efficiency, heat resistance, and cost.

### Second Embodiment

### [2-1 Configuration of Phosphor Wheel]

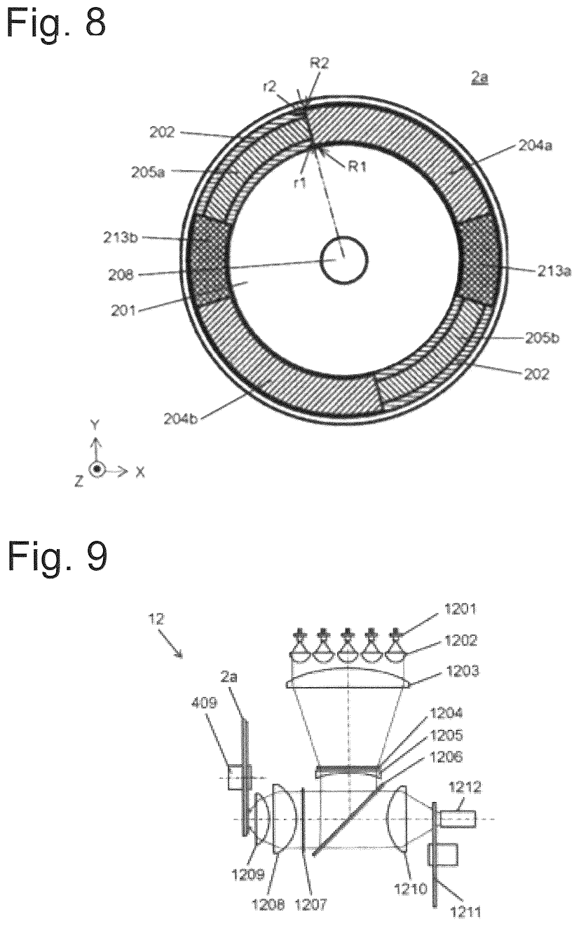

A configuration of a phosphor wheel 2a according to a second embodiment will hereinafter be described in detail. FIG. 8 is a front view of the phosphor wheel 2a according to the second embodiment. In the following description, new elements in the phosphor wheel 2a according to the second embodiment will be described, and the constituent elements already described in FIG. 1 will not be described again.

The phosphor wheel 2a according to the second embodiment differs from the phosphor wheel 2 according to the first embodiment in that it includes reflective regions 213a and 213b in place of the openings. The reflective regions 213a and 213b reflect excitation light as itis. The reflective regions 213a and 213b can be configured as regions not having the wavelength conversion layers 204a, 204b, 205a, and 205b formed therein, among the regions of the adhesive layer (reflective layer) formed on the substrate 201.

Although the reflective regions 213a and 213b are arranged at substantially the same positions as those of the openings of the phosphor wheel 2 according to the first embodiment, the present invention is not limited thereto. The number of the reflective regions 213a and 213b is not limited to two, and may be two or more.

In the case of disposing the reflective regions instead of the openings in this manner, all light is obtained as reflected light. Thus, there is no need to consider the optical path for photosynthesis between the excitation light that has passed through the opening to undergo a wavelength change and the reflected light.

### [2-2 Light Source Device]

Hereinafter, details of a light source device 12 of a second example using the phosphor wheel according to the second embodiment will be described. FIG. 9 is a diagram showing a configuration of the light source device 12 of the second example that uses the phosphor wheel 2a according to the second embodiment. From now on, description will be given using the phosphor wheel 2a according to the second embodiment shown in FIG. 8.

Laser light in a blue wavelength range emitted from a plurality of laser light sources 1201 is collimated by a plurality of collimator lenses 1202 arranged corresponding to each of the laser light sources 1201. The collimated blue light enters a succeeding convex lens 1203 to reduce its luminous flux width and then enters a succeeding diffuser plate 1204 which follows for diffusion to improve the uniformity of light. The blue light having light uniformity improved by the diffuser plate 1204 is incident on a succeeding concave lens 1205 and collimated into a parallel luminous flux.

Incidentally, the optical system up to the concave lens 1205 adjusts the polarization direction of the laser light so that the laser light becomes S-polarized light with respect to a polarization and color separation/combining mirror 1206 that will be described later when the laser light is output from the concave lens 1205.

The blue light collimated into a parallel luminous flux by the concave lens 1205 impinges on the polarization and color separation/combining mirror 1206 disposed at an inclination angle of approx. 45 degrees to the optical axis and changes the direction of travel of the light by 90 degrees, to enter a succeeding π/4 wavelength plate 1207. The polarization and color separation/combining mirror 1206 has spectral characteristics that reflect S-polarized light having a blue wavelength range emitted from the laser light sources 1201 and that transmit P-polarized light having a blue wavelength range emitted from the laser light sources 1201 and light having a fluorescence wavelength range obtained by wavelength-converting in the phosphor wheel 2a described later the blue light that is excitation light emitted from the laser light sources 1201.

The polarization direction of the blue light from the laser light sources 1201 incident on the π/4 wavelength plate 1207 is rotated, changing it to circular polarization.

The light leaving the π/4 wavelength plate 1207 enters a convex lens 1208 and then, under cooperation with a succeeding convex lens 1209, enters the reflective regions 213a and 213b and the wavelength conversion layers 204a, 204b, 205a, and 205b disposed on the succeeding phosphor wheel 2a. A motor 409 is disposed on the phosphor wheel 2a and is arranged to allow, around its rotation axis, blue excitation light condensed by the convex lenses 1108 and 1109 to impinge on the reflective regions 213a and 213b and the wavelength conversion layers 204a, 204b, 205a, and 205b.

First, the blue light condensed on the wavelength conversion layers 204a, 204b, 205a, and 205b of the phosphor wheel 2a by the convex lenses 1208 and 1209 is converted into fluorescence and changes the direction of travel of the light by 180 degrees to reenter the convex lenses 1209 and 1208 in the mentioned order to be collimated into a parallel luminous flux. The fluorescence wavelength-converted by the phosphor wheel 2a has wavelength regions optimized to form, for example, white light in cooperation with the blue light emitted from the laser light sources 1201.

The fluorescence collimated into a parallel luminous flux by the convex lens 1208 and output therefrom passes through the π/4 wavelength plate 1207 and reenters the polarization and color separation/combining mirror 1206 arranged at the angle of 45 degrees to the optical axis. Since as described earlier, the polarization and color separation/combining mirror 1206 has the characteristic of transmitting light having a fluorescence wavelength range, it transmits fluorescence intactly without changing the direction of the light, allowing the fluorescence to enter a succeeding convex lens 1210.

Next, the blue light from the laser light sources 1201 condensed onto the reflective regions 213a and 213b of the phosphor wheel 2a is reflected on the reflective regions 213a and 213b of the phosphor wheel 2a to change its direction of travel by 180 degrees, and enters the convex lenses 1209 and 1208 in the mentioned order, to be collimated into a parallel luminous flux.

The blue light collimated into a parallel luminous flux by the convex lenses 1209 and 1208 enters the succeeding π/4 wavelength plate 1207 to rotate its direction of polarization to be converted into P-polarized light for emission.

The light of P-polarized light having blue wavelength range output from the π/4 wavelength plate 1207 impinges on the polarization and color separation/combining mirror 1206 arranged at the angle of approx. 45 degrees to the optical axis. The polarization and color separation/combining mirror 1206 has characteristics that reflect the light of S-polarized light having a blue wavelength range emitted from the laser light sources 1201 and transmit the light of P-polarized light having a blue wavelength range emitted from the laser light sources 1201 and the light having a fluorescence wavelength range wavelength-converted by the phosphor wheel 2a. Therefore, the light of P-polarized light having a blue wavelength range output from the π/4 wavelength plate 1207 passes through as it is without changing the direction of travel of the light, to enter the succeeding convex lens 1210.

The convex lens 1210 receives the fluorescence and the blue light in a time series depending on the rotation of the phosphor wheel 2a and condenses them onto the vicinity of the entrance end of a rod integrator 1212 that will be described later. The light condensed by the convex lens 1210 enters a color filter wheel 1211. The color filter wheel 1211 has a configuration similar to that of the color filter wheel 1110 employed in the light source device 11 that employs the phosphor wheel according to the first embodiment, and when the phosphor wheel 2a and the color filter wheel 1211 rotate in synchronism, light having a different light wavelength range is condensed in a time series in the vicinity of the entrance end of the rod integrator 1212.

The light having a wavelength range different in a time-division manner incident on the rod integrator 1212 is homogenized by the rod integrator 1212 and output from the exit end. Although in the explanation of FIG. 9, the color filter wheel 1211 is disposed near the entrance side of the rod integrator 1111, it may be disposed near the exit side thereof.

### <Effect>

In the light source device 12 that uses the phosphor wheel 2a according to the second embodiment, balance can be achieved between conversion efficiency, heat resistance, and cost.

### [2-3 Projection Type Image Display Device]

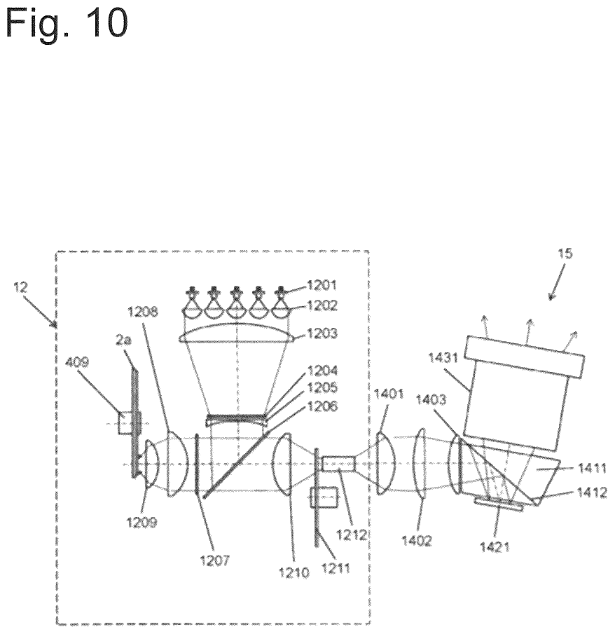

Hereinafter, description will be given of details of a projection type image display device 15 employing the light source device 12 that uses the phosphor wheel 2a according to the second embodiment. FIG. 10 is a diagram showing a configuration of the projection type image display device 15 employing the light source device 12 that uses the phosphor wheel 2a according to the second embodiment.

Since the configuration of the light source device 12 using the phosphor wheel 2a according to the second embodiment has been described above, the description thereof will be omitted here. The behavior of light after emission from the rod integrator 1212 in the projection type image display device 15 shown in FIG. 10 is substantially the same as the behavior of light after emission from the rod integrator 1111 that has been described in the projection type image display device 14 shown in FIG. 7, the same reference numerals are imparted and the description thereof will be omitted here.

### <Effect>

In the projection type image display device 15 using the light source device 12 that uses the phosphor wheel 2a according to the second embodiment, balance can be achieved between conversion efficiency, heat resistance, and cost.

### Third Embodiment

### [3-1 Configuration of Phosphor Wheel]

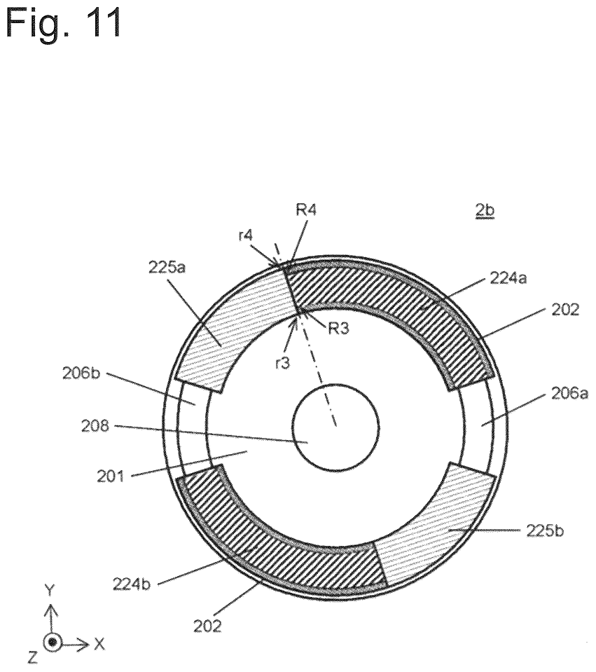

A configuration of a phosphor wheel 2b according to a third embodiment will hereinafter be described in detail. The same constituent elements as those of the first and second embodiments are designated by the same reference numerals and explanation thereof will be omitted. FIG. 11 is a schematic plan view showing a planar configuration of the phosphor wheel 2b according to the third embodiment. As shown in FIG. 11, the phosphor wheel 2b includes the rotatable substrate 201, a plurality of wavelength conversion layers 224a, 224b, 225a, and 225b, and the adhesive layer 202 (reflective layer) disposed between the substrate 201 and the plurality of wavelength conversion layers 224a, 224b, 225a, and 225b.

The plurality of wavelength conversion layers 224a, 224b, 225a, and 225b are arranged on the substrate 201 and wavelength-convert the same excitation light into light having a plurality of different wavelengths. The plurality of wavelength conversion layers 224a, 224b, 225a, and 225b include sintered body type wavelength conversion layers 224a and 224b and mixed layer type wavelength conversion layers 225a and 225b. The sintered body type wavelength conversion layers 224a and 224b are made of a sintered body of first wavelength conversion particles that wavelength-convert excitation light into light of a first wavelength. The mixed layer type wavelength conversion layers 225a and 225b are mixed layers of a support and second wavelength conversion particles filled in the support that wavelength-convert excitation light into light of a second wavelength.

According to this phosphor wheel 2b, because of having the sintered body type wavelength conversion layers 224a and 224b and the mixed layer type wavelength conversion layers 225a and 225b, an excellent balance is achieved between the conversion efficiency, heat resistance, and cost.

Members making up this phosphor wheel 2b will be described below.

### <Wavelength Conversion Layer>

The wavelength conversion layers include the sintered body type wavelength conversion layers 224a and 224b and the mixed layer type wavelength conversion layers 225a and 225b. These wavelength conversion layers 224a, 224b, 225a, and 225b are arranged on the substrate 201 along the same circumference around the rotation center of the substrate 201. Similar to the first embodiment, the substrate defines the openings 206a and 206b disposed on the same circumference. Alternatively, as shown in the second embodiment, reflective regions may be disposed instead of the openings, to configure the phosphor wheel. The sintered body type wavelength conversion layers 224a and 224b and the mixed layer type wavelength conversion layers 225a and 225b may be adjacent to each other on the same circumference or may be adjacent with the openings 206a and 206b in between. The sintered body type wavelength conversion layers 224a and 224b and the mixed layer type wavelength conversion layers 225a and 225b may be adjacent with a small gap in between because the temperature increases when they overlap.

In the sintered body type wavelength conversion layers 224a and 224b and the mixed layer type wavelength conversion layers 225a and 225b, at least one of inner radii R3 and r3 and outer radii R4 and r4 from the rotation center of the substrate may differ. In the third embodiment, different from the cases of the first and second embodiments, as shown in FIG. 11, the inner radius R3 of the sintered body type wavelength conversion layers 224a and 224b is greater than the inner radius r3 of the mixed layer type wavelength conversion layers 225a and 225b (R3>r3), while the outer radius R4 of the sintered body type wavelength conversion layers 224a and 224b is less than the outer radius r4 of the mixed layer type wavelength conversion layers 225a and 225b (R4<r4).

Also, the mixed layer type wavelength conversion layers 225a and 225b and the sintered body type wavelength conversion layers 224a and 224b may be different in the radial width from the rotation center of the substrate 201. In the third embodiment, different from the cases of the first and second embodiments, as shown in FIG. 11, the radial width (r4−r3) of the mixed layer type wavelength conversion layers 225a and 225b is greater than the radial width (R4−R3) of the sintered body type wavelength conversion layers 224a and 224b, that is, the relationship of (r4−r3)>(R4−R3) is established.

By allowing at least one of: the inner radii R3 and r3 of the sintered body type wavelength conversion layers 224a and 224b and the mixed layer type wavelength conversion layers 225a and 225b; and the outer radii R4 and r4 of the sintered body type wavelength conversion layers 224a and 224b and the mixed layer type wavelength conversion layers 225a and 225b to differ from each other, guide pins around the sintered body of first wavelength conversion particles can be arranged, radially offset from the locations where the mixed layer type wavelength conversion layers are disposed. This facilitates the alignment upon adhering the sintered body type wavelength conversion layers 224a and 224b to the substrate.

### <Sintered Body Type Wavelength Conversion Layer>

Similar to the sintered body type wavelength conversion layers 204a and 204b described in the first embodiment, the sintered body type wavelength conversion layers 224a and 224b are made of a sintered body of the first wavelength conversion particles that wavelength-convert the excitation light into light of the first wavelength.

<Mixed Layer Type Wavelength Conversion Layer>Similar to the mixed layer type wavelength conversion layers 205a and 205bb described in the first embodiment, the mixed layer type wavelength conversion layers 225a and 225b are mixed layers of the support and the second wavelength conversion particles filled in the support that wavelength-convert the excitation light into light of the second wavelength.

### <Adhesive Layer>

The adhesive layer 202 is disposed between the substrate 201 and the sintered body type wavelength conversion layers 224a and 224b and between the substrate 201 and the mixed layer type wavelength conversion layers 225a and 225b. The adhesive layer 202 is disposed to adhere the sintered body type wavelength conversion layers 224a and 224b to the substrate 201 and acts as a reflective layer that reflects first light generated by wavelength conversion by the sintered body type wavelength conversion layers 224a and 224b and second light generated by wavelength conversion by the mixed layer type wavelength conversion layers 225a and 225b. The reflective layer also reflects excitation light that was not absorbed by the sintered body type wavelength conversion layers 224a and 224b and the mixed layer type wavelength conversion layers 225a and 225b. The excitation light reflected by the reflective layer is absorbed again in the sintered body type wavelength conversion layers 224a and 224b or the mixed layer type wavelength conversion layers 225a and 225b and is converted into the first light or the second light. This improves the efficiency of wavelength conversion in the sintered body type wavelength conversion layers 224a and 224b and the mixed layer type wavelength conversion layers 225a and 225b. The inner and outer radii of the adhesive layer 202 are substantially the same as the inner radius r3 and the outer radius r4, respectively, of the mixed layer type wavelength conversion layers 225a and 225b. That is, the width of the adhesive layer 202 is substantially the same as the width of the mixed layer type wavelength conversion layers 225a and 225b and is greater than the width of the sintered body type wavelength conversion layers 224a and 224b. Hence, the adhesive layer 202 is exposed on both sides in the radial direction of the sintered body type wavelength conversion layers 224a and 224b.

### <Method for Producing Phosphor Wheel>

A method for producing the phosphor wheel 2b according to the third embodiment includes the steps shown in the flowchart of FIG. 2 described in the first embodiment.

At step S01, adhesive paste for forming an adhesive layer (reflective layer) is discharged and applied from an application nozzle of a coater onto a portion of the substrate 201 where the sintered body type wavelength conversion layers 224a and 224b and the mixed layer type wavelength conversion layers 225a and 225b are disposed. The application width of the adhesive layer can be controlled by the diameter of the application nozzle that discharges adhesive paste.

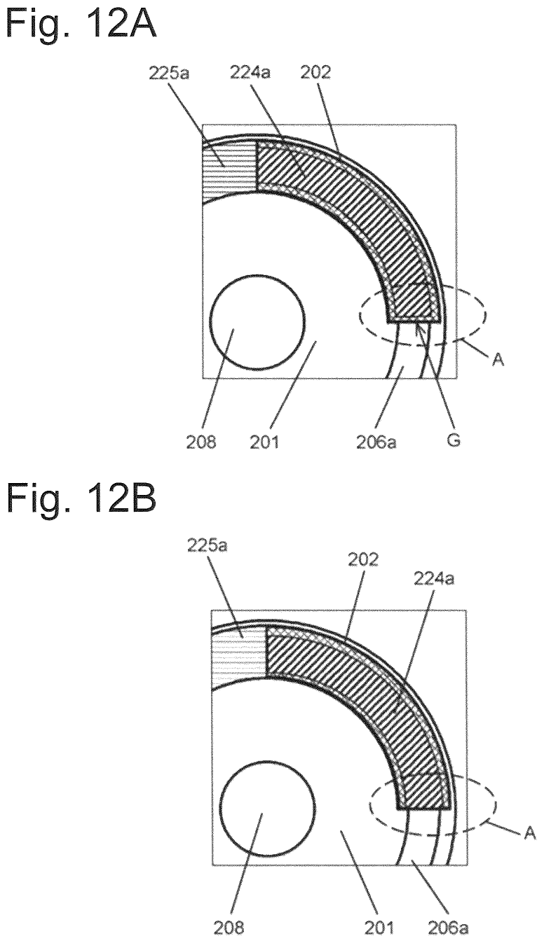

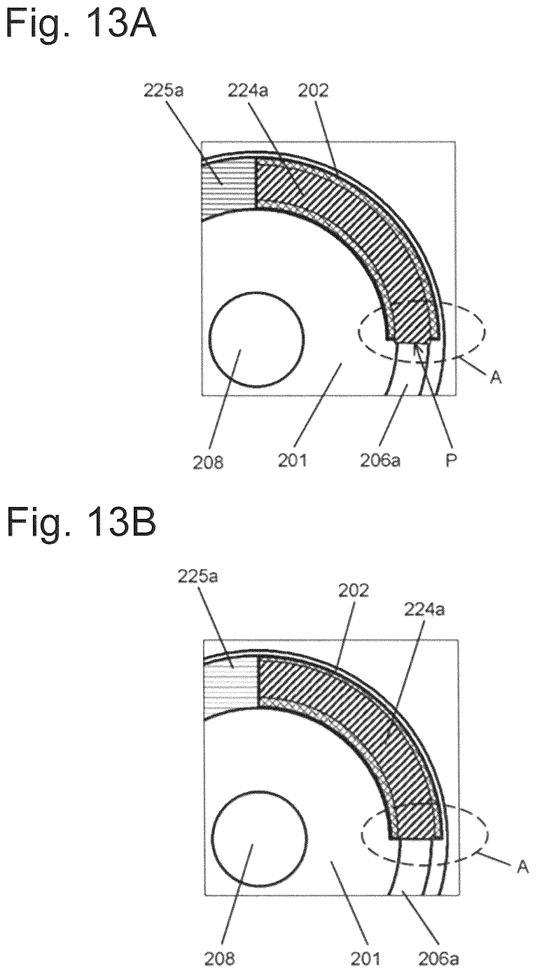

At step S02, the sintered body type wavelength conversion layers 224a and 224b are aligned and stuck onto the adhesive layer 202 applied to the substrate 201. FIGS. 12A, 12B, 13A and 13B are diagrams explaining the alignment of the sintered body type wavelength conversion layers at the time of producing the phosphor wheel according to the third embodiment. FIGS. 12A and 12B show the case where the center angle of the sintered body type wavelength conversion layer to be stuck is smaller than the design value, and FIGS. 13A and 13B show the case where it is larger than the design value. Although the diagrams depict the vicinity of the sintered body type wavelength conversion layer 224a of the phosphor wheel 2b, the same applies to the vicinity of the sintered body type wavelength conversion layer 224b.

In the case that the center angle of the sintered body type wavelength conversion layer to be stuck is smaller than the design value, when trying to position the sintered body type wavelength conversion layer 224a at the center of the width of the adhesive layer 202, as shown in a portion A of FIG. 12A, the end of the sintered body type wavelength conversion layer 224a does not reach the boundary between the adhesive layer 202 and the opening 206a, with the result that a gap G in which the adhesive layer 202 is exposed occurs between the end of the sintered body type wavelength conversion layer 224a and its boundary. In this case, since the adhesive layer 202 is exposed without the sintered body type wavelength conversion layer 224a in the gap G, the excitation light incident on the phosphor wheel 2b is reflected as it is.

FIG. 12B shows the case where the sintered body type wavelength conversion layer 224a is stuck so as to prevent the gap G from occurring by shifting the sintered body type wavelength conversion layer 224a toward the opening 206 to position the end of the sintered body type wavelength conversion layer 224a at the boundary between the adhesive layer 202 and the opening 206a. In this case, on the side toward the mixed layer type wavelength conversion layer 225a in particular, the sintered body type wavelength conversion layer 224a is shifted from the center in the width of the adhesive layer 202 toward the rotation center of the substrate 201. However, since the width of the adhesive layer 202 is wider than that of the sintered body type wavelength conversion layer 224a as described above, the entire reverse side (i.e., surface facing the substrate 201) of the sintered body type wavelength conversion layer 224a can more securely be stuck onto the substrate 201 by the adhesive layer 202.

In the case that the center angle of the sintered body type wavelength conversion layer to be stuck is larger than the design value, when trying to position the sintered body type wavelength conversion layer 224a at the center of the width of the adhesive layer 202, as shown in a portion A of FIG. 13A, the end of the sintered body type wavelength conversion layer 224a protrudes beyond the boundary between the adhesive layer 202 and the opening 206a into the opening 206a, resulting in occurrence of a protruding portion P. When the protruding portion P occurs, fluorescence generated in the protruding portion P by the excitation light is not reflected by the adhesive layer 202 (reflective layer), leading to lower reflection efficiency. In addition, since the protruding portion P is not stuck by the adhesive layer 202, the sintered body type wavelength conversion layer 224a is easy to peel off from the protruding portion P.

FIG. 13B shows the case where the sintered body type wavelength conversion layer 224a is stuck so as to prevent the protruding portion P from occurring by shifting the sintered body type wavelength conversion layer 224a from the opening 206a toward the adhesive layer 202 to position the end of the sintered body type wavelength conversion layer 224a at the boundary between the adhesive layer 202 and the opening 206a. In this case, on the side toward the mixed layer type wavelength conversion layer 225a in particular, the sintered body type wavelength conversion layer 224a is shifted from the center in the width of the adhesive layer 202 toward the outer periphery of the substrate 201. However, since the width of the adhesive layer 202 is wider than that of the sintered body type wavelength conversion layer 224a as described above, the entire reverse side of the sintered body type wavelength conversion layer 224a can more securely be stuck onto the substrate 201 by the adhesive layer 202.

Thus, in the phosphor wheel 2b of the third embodiment, the width of the adhesive layer 202 (reflective layer) is wider than the width of the sintered body type wavelength conversion layers 224a and 224b, even if the dimensions of the sintered body type wavelength conversion layers 224a and 224b are smaller or larger than the design values, the entire reverse sides of the sintered body type wavelength conversion layers 224a and 224b can securely be adhered to the substrate 201 while aligning the ends of the sintered body type wavelength conversion layers 224a and 224b at the boundary between the adhesive layer 202 and the opening 206a.

At step S04, a mixed layer for forming the mixed layer type wavelength conversion layers 225a and 225b is applied onto the hardened adhesive layer 202 on the substrate 201. The width of application of the mixed layer can be controlled by the diameter of the application nozzle. Since as described above, the width of the mixed layer type wavelength conversion layers 225a and 225b is substantially the same as the width of the adhesive layer 202, it is possible to use in common the application nozzle for applying the mixed layer and the application nozzle with the same diameter for applying the adhesive layer. When a common application nozzle can be used for adhesive layer application step (S01) and the mixed layer application step (S04), a mistake of using a wrong application nozzle at the working steps can be prevented. Due to no need for separately preparing the application nozzle in each of the adhesive layer application step (S01) and the mixed layer application step (S04), the purchasing cost for application nozzle can be curtailed.

### [3-2 Light Source Device & Projection Type Image Display Device]

The phosphor wheel 2b according to the third embodiment can make up a light source device and a projection type image display device by replacing the phosphor wheel 2 of the light source device 11 (FIG. 6) and the projection type image display device 14 (FIG. 7) described in the first embodiment. Furthermore, similar to the case described in the second embodiment, the phosphor wheel 2b according to the third embodiment can be configured as a phosphor wheel in which the openings 206a and 206b are replaced by the reflective regions 213a and 213b. The phosphor wheel 2 having the reflective regions 213a and 213b in place of the openings 206a and 206b of the phosphor wheel 2b can make up a light source device and a projection type image display device by replacing the phosphor wheel 2a of the light source device 12 (FIG. 9) and the projection type image display device 15 (FIG. 10) described in the second embodiment. Also, in the light source device and projection type image display device that use the phosphor wheel 2b (including the phosphor wheel in which the openings 206a and 206b are replaced by the reflective regions 213a and 213b) according to the third embodiment, balance can be achieved between the conversion efficiency, heat resistance, and cost, similar to the light source device 11 of the first embodiment.

The present disclosure encompasses appropriate combination of any embodiment and/or examples, among the various embodiments and/or examples set forth hereinabove, whereby the effects of the embodiments and/or examples can be provided.

The phosphor wheel according to the present disclosure includes the sintered body type wavelength conversion layers and the mixed layer type wavelength conversion layers. This ensures balance between the conversion efficiency, heat resistance, and cost.

### EXPLANATION OF REFERENCES

2, 2a, 2b phosphor wheel
201 substrate
202 adhesive layer
204, 204a, 204b, 224a, 224b sintered body type wavelength conversion layer
205a, 205b, 225a, 225b mixed layer type wavelength conversion layer
206, 206a, 206b opening
208 motor mounting hole
210 sticking base
211 guide pin
212a, 212b, 212c guide pin
213a, 213b reflective region
11 light source device
1101 laser light source
1102 collimator lens
1103 convex lens
1104 diffuser plate
1105 concave lens
1106 color separation/combining mirror
1107 convex lens
1108 convex lens
309 motor
1109 convex lens
1110 color filter wheel
1111 rod integrator
1121 convex lens
1122 convex lens
1123 mirror
1124 convex lens
1125 mirror
1126 convex lens
1127 mirror
1128 convex lens
12 light source device
1201 laser light source
1202 collimator lens
1203 convex lens
1204 diffuser plate
1205 concave lens
1206 polarization and color separation/combining mirror
1207 π/4 wavelength plate
1208 convex lens
1209 convex lens
409 motor
1210 convex lens
1211 color filter wheel
1212 rod integrator
14, 15 projection type image display device
1401 convex lens (relay lens)
1402 convex lens (relay lens)
1403 convex lens (relay lens)
1411 total reflection prism
1412 minute gap
1421 DMD 1421
1431 projection lens
R1, R3, r1, r3 inner radius
R2, R4 r2, r4 outer radius

What is claimed is:

1. A phosphor wheel comprising:
a rotatable substrate;
a plurality of wavelength conversion layers; and
an adhesive layer disposed between the substrate and the plurality of wavelength conversion layers,
the plurality of wavelength conversion layers including a first wavelength conversion layer and a second wavelength conversion layer,
at least the first wavelength conversion layer among the plurality of wavelength conversion layers being a sintered body type wavelength conversion layer made of a sintered body of first wavelength conversion particles that wavelength-convert excitation light into light of a first wavelength,
at least the second wavelength conversion layer among the plurality of wavelength conversion layers being a mixed layer type wavelength conversion layer that is a mixed layer of a support and second wavelength conversion particles filled in the support that wavelength-convert the excitation light into light of a second wavelength different from the first wavelength.

2. The phosphor wheel according to claim 1,
wherein the first wavelength conversion layer and the second wavelength conversion layer are arranged adjacent to each other on the substrate.

3. The phosphor wheel according to claim 2,
wherein the first wavelength conversion layer and the second wavelength conversion layer have their respective inner radii and their respective outer radii, at least one of the inner radii or the outer radii being different between the first wavelength conversion layer and the second wavelength conversion layer.

4. The phosphor wheel according to claim 2,
wherein the first wavelength conversion layer and the second wavelength conversion layer have different widths in a radial direction from a rotation center of the substrate.

5. The phosphor wheel according to claim 2,
wherein the inner radius of the first wavelength conversion layer from a rotation center of the substrate is larger than the inner radius of the second wavelength conversion layer from the rotation center of the substrate, and wherein
the outer radius of the first wavelength conversion layer from the rotation center of the substrate is smaller than the outer radius of the second wavelength conversion layer from the rotation center of the substrate.

6. The phosphor wheel according to claim 1,
wherein the substrate defines an opening disposed on an identical circumference around a rotation center of the substrate on which the plurality of wavelength conversion layers are arranged.

7. The phosphor wheel according to claim 1, comprising:
a reflective region disposed on an identical circumference around a rotation center of the substrate on which the plurality of wavelength conversion layers are arranged.

8. A light source device comprising the phosphor wheel according to claim 1.

9. A projection type image display device comprising the light source device according to claim 8.

10. A method for producing a phosphor wheel, comprising:
applying an adhesive layer onto a substrate;
sticking onto the substrate a sintered body of first wavelength conversion particles that wavelength-convert excitation light into light of a first wavelength;
hardening the adhesive layer to form a sintered body type wavelength conversion layer;
applying a mixed layer onto a substrate on a circumference identical to that of the sintered body type wavelength conversion layer, the mixed layer being made of a mixture of a support and second wavelength conversion particles that wavelength-convert the excitation light into light of a second wavelength different from the first wavelength; and
hardening the mixed layer to form a mixed layer type wavelength conversion layer.

11. The method for producing a phosphor wheel according to claim 10,
wherein the step of forming the sintered body type wavelength conversion layer includes:
disposing a guide pin for alignment around a sintered body of the first wavelength conversion particles;
relatively moving, along the guide pin, the substrate and the sintered body of the first wavelength conversion particles in a direction normal to a surface; and
sticking the sintered body of the first wavelength conversion particles onto a site of the substrate where the adhesive layer is applied.

12. The method for producing a phosphor wheel according to claim 11,
wherein the step of forming the mixed layer type wavelength conversion layer includes:
applying the mixed layer in which the second wavelength conversion particles and the support are mixed, onto the substrate at a site adjacent to the sintered body of the first wavelength conversion particles, other than a site corresponding to the guide pin.
